(19) United States
(12) Patent Application Publication
(10) Pub. No.: US 2002/0121610 A1
(43) Pub. Date: Sep. 5, 2002

(54) FLUORESCENCE CORRELATION SPECTROSCOPY MODULE FOR A MICROSCOPE

(76) Inventors: MICHAEL TEWES, HEIDELBERG (DE); JORG LANGOWSKI, HEIDELBERG (DE)

Correspondence Address: COLLARD & ROE, 1077 NORTHERN BOULEVARD, ROSLYN, NY, 11576

(21) Appl. No.: 09/319,092

(22) PCT Filed: Nov. 26, 1997
(86) PCT No.: PCT/DE97/02776

(30) Foreign Application Priority Data
Nov. 29, 1996 (DE) 196 49 605.5

(51) Int. Cl. G01N 21/64

(52) U.S. Cl. 250/458.1

(57) ABSTRACT

The proposal comprises a module (1) for attachment to a microscope (3), by means of which the said microscope can be used for fluorescence correlation spectroscopy.

The invention concerns a fluorescence correlation spectroscopy module for a microscope according to the introductory clause in claim 1. The invention also concerns a microscope equipped with such a module according to claim 18 and its application.

Fluorescence correlation spectroscopy (FCS) is a technology for studying and investigating molecularly dynamic processes For this purpose, particles in a solution are endowed with colorants capable of fluorescing; said colorants are then stimulated by light with a given wavelength to emit light quanta that can be picked up and evaluated through detectors A confocal pinhole array is then used to ensure that only the light quanta issued by the focal plane of a microscope reach the detectors at any given moment and are thus available for evaluation.

Known fluorescence correlation spectroscopy devices consist of a microscope with an optical array built into it. The stimulation light is provided by a laser. The laser light is steered through a deviating lens to the microscope lens and the sample to be investigated. As a consequence of the construction of such a known apparatus, which entails the pinhole array being set at a distance from the point where the stimulation light is coupled into the microscope, this known apparatus has the considerable disadvantage that it often requires readjustment, in order to maintain the confocal direction of the beam path, which is a great disadvantage for example when measuring in series.

One reason for this disadvantage is that heat-induced expansion is naturally caused in this known device, which leads to considerable problems, in particular in the case of the above-mentioned series measurements and especially with respect to the reproducibility of results. One reason for this problem is the large distance between the coupling and the pinhole array, so that thermal expansion leads to a de-adjustment of the lens. A further disadvantage of this known apparatus is that it is only available in integral form, i.e. with the lens integrated into the microscope. This integration, however, leads to high manufacturing costs for the known device. This form of construction, together with the great distance between the coupling and the pinhole array, also means that oscillations for example in the sample table lead to a de-adjustment of the beam path, as the complete unit of microscope plus lens is stimulated to oscillations that are transmitted in amplified form to the lens by the body of the microscope's housing. This in turn makes it difficult to reproduce the results of measurements made in series.

The lens system of a microscope is used in the fluorescence correlation spectroscopy technique. Many of the users who are liable to need to apply the said technique already have such a microscope, for example a research microscope, at their disposal.

The task of the invention in question therefore builds upon this premise for the purpose of enabling such an already available microscope to be used for fluorescence correlation spectroscopy by creating an FCS module and at the same time ensuring that the measurement results will have a good degree of reproducibility. In addition, it aims at creating a microscope with a fluorescence correlation spectroscopy module.

In order to fulfil this task with regard to the module, the invention relies on the characteristics listed in claim 1. Preferred embodiments thereof are described in the subsequent claims. The microscope to be provided has the characteristics listed in claim 18. Applications thereof are described in claims 19 through 21.

The invention is based on the substantial presumption that many users who are liable to use fluorescence correlation microscopy already have preferably an inverse microscope for research purposes or something comparable at their disposal However, these known microscopes cannot be used for fluorescence correlation microscopy. At the same time, these users often possess a laser applied for making other measurements that emits light in known wavelengths.

The invention now provides a module with which it is possible to apply available microscopes to fluorescence correlation spectroscopy and, moreover, to make the array thus provided efficient for series measurements with a high degree of reproducibility of the results.

The invention therefore provides for a fluorescence correlation spectroscopy module to be arrayed in an optical connection with a microscope with a connection to the coupling of the stimulating light and a pinhole array, in which the coupling connection and the pinhole array are situated on a common support body.

The stimulating light can be coupled into the module at the coupling connection by means of a beam waveguide, preferably a single mode fiber optical waveguide, whereby the stimulating light issues from a laser transmitter that emits stimulating light with one or more wavelengths. The coupling connection and the pinhole array are situated in physical proximity to the common support body, which is rigid in form, so that any thermal expansion of the said Support body cannot lead to the de-adjustment of an already adjusted beam path.

The module only contains a few optical elements, so as to avoid or reduce the optical losses normally arising as a consequence of the larger number of such optical elements, while also minimising the errors in the beam path caused by said optical elements.

The module can be flange-mounted on an optical connection on a microscope, an operation that calls for an optical inlet and/or outlet on the microscope. Microscopes used for research usually have such connections, which are provided for attaching electronic cameras, for example CCD cameras. At such a connection, it is possible to intervene on the microscope's intermediate image, so that light can also be coupled into the microscope through this connection and can then be fed through the lens onto the sample volumes. These sample volumes contain the particles treated with colorants suitable for fluorescence, which are stimulated to fluorescence by the stimulating light coupled in. The light quanta thus generated are fed back to the optical connection through the microscope lens and then on into the support body and the pinhole array.

According to the invention, a collimator for generating a parallel light beam at the support body is arrayed in the beam path after the coupling connection of said support body.

An adjustable lens array fox focusing the beam path confocally to the pinhole is provided in the said beam path after the collimator. The purpose of this lens array is to bring the light source (end of the fiber optical waveguide) to cover with the pinhole array in the image plane of the microscope. An adjustment device, such as a micrometer screw or a pulse motor, can be used to adjust the lens array in all directions.

A filter array and a dichroic beam splitter can be provided in the microscope before the stimulating light coupling. The preferably narrow-band filter ensures that the stimulating light of only selected wavelength reaches the sample volumes on the microscopes specimen slide and that this light passes through the dichroic beam splitter.

According to the invention, provision is thus made for the filter array and the beam splitter to be situated on a common receptacle holder, which can be attached removably to the support body. This receptacle holder is understood as a support on which filters and beam splitters with the specific optical properties desired for the individual case of application can be mounted in advance, so that the receptacle holder can then be inserted in the support body together with the said optical components as a single unit. This not only provides for an array that is easy to handle, as the relative holders with previously mounted optical elements, each with its own specific properties, such as frequency selection, can be held ready for different purposes, it can also cater for the requirement of physical proximity in the array.

In the further development of the invention, at least one optical unit with a dichroic beam splitter or a mirror is provided in the emission beam path behind the pinhole. When there is a dichroic beam splitter present, the function of this optical unit is to ensure that a spectrum of the emission beam can be decoupled towards a detector at a relative frequency-selective property of the beam splitter, while another color can continue to penetrate from the emission beam through the beam splitter, remaining Substantially unaffected, so that it can then strike a second optical unit arrayed behind the first said optical unit in the beam path of the emission beam by means of a mirror, whence this color then strikes a second detector arrayed with respect to the second optical unit for the purpose of identifying emitted light quanta of the second wavelength. This array is particularly advantageous in the case of cross-correlation with two color channels, with which the reciprocal relationships between colorant-bearing particles in the solution can be investigated.

The at least one optical unit is preferably arrayed on a receptacle holder that can be inserted removably in the support body. Paired combinations of filters and beam splitters set opposite each other are preferably provided on the said receptacle holder, so that it is possible to make a rapid frequency selection in view of the emission beam by removing the receptacle holder from the support body, turning the receptacle holder through 180° and then reinserting it into the support body.

The purpose of the filter provided for on the optical unit is to select the detection wavelength, i.e. to select the spectra of emission beam to be used for the investigation, so that several emission spectra of the fluorescence beam can be investigated, expressed in a correlative relationship and correspondingly evaluated by arraying several optical units with combinations of filters, beam splitters and mirrors, or any sub-combinations of these components, in the emission beam path.

In this way it is possible, for example, to use three colors (different wavelengths of the emission spectrum) at the same time for the investigation, through three optical units with the above-mentioned optical components set in the emission beam path, so that in this case two optical units are used with combinations of dichroic beam splitter and filter followed by a combination of mirror and filter, one after the other in the emission beam path, arrayed on receptacle holders in the support body. Frequency-selected impulses counted individually by the relative detectors can thus be used for cross-correlated evaluation.

In this way, a lens array for focusing the emission light on the sensitive field of the detector can be provided before each detector in the emission beam path.

The module according to the invention is formed in such a way that it is always possible to adjust the few optical components. For this purpose, the support body is fitted with surfaces shaped to receive the receptacle holder with the optical components, to which the receptacle holders, endowed with complementarily shaped surfaces, can be attached on the support body arrayed in the beam path. These shaped surfaces have a centering function, so that optical elements that have once been arrayed on the receptacle holder oriented towards the beam path of the emission beam will also remain oriented if the receptacle holder is taken out of the cavities in the support body and then reinserted in it. This is of advantage, for example, if one combination of filter and dichroic beam splitter has to be replaced by another comparable combination that is arrayed on the same receptacle holder, only opposite the first combination. In this the case, the receptacle holder need only be removed from the support body, turned through 180° and then reinserted in the cavity in the support body, when the shaped surfaces provided on the support body and won the receptacle holder, for example conical surfaces, will then ensure that the new combination of filter and dichroic mirror is arrayed with an orientation in the beam path, so that it is possible to continue measuring without any further adjustments.

The support body may consist of a one-piece metal tool and have a connection flange for joining the support body to the microscope's connection. For this purpose, for example, the support body can be produced in alluminum using a CNC control machine tool.

The laser light can be coupled into the module via a single mode fiber optical waveguide. The collimator for parallel orientation of the light beam is situated behind the flange for connecting the fiber optical waveguide. The diameter of this beam determines the portion of the aperture that is used to illuminate the sample. The collimator must therefore be tuned to the numerical aperture of the fiber optical waveguide.

Using a microscope fitted with the module according to the invention, it is possible to determine diffusion coefficients. The possibility to pick up fluorescence signals at the same time in different spectral ranges, through two or more optical units with relative optical components arrayed one after another, enables these signals to be drawn into cross-correlation and thus reciprocal effects of the various molecules to be found in the sample volumes to be investigated. It is also possible to use this to determine rotation diffusion coefficients, as the emission beam is distributed with two optical units in equal parts to two detectors and the cross-correlation function is once more formed, enabling very small diffusion times to be measured. The polarizers necessary for this process can be built into the receptacle holder.

Using the fluorescence correlation spectroscopy module according to the invention, it is possible to up-grade available microscopes so that fluorescence correlation spectroscopy can be undertaken with the aid of a laser and conventional laboratory equipment, in the form of an evaluation computer with a correlator pcb. Furthermore, it is possible to carry out cross-correlation analyses In addition to the characteristic of the price-effective up-grading of available microscopes, the physically compact unit of the module enables a good degree of reprodicibility of results to be achieved, as a result of eliminating the need to readjust the optical elements. Optical losses and imaging errors are minimized as a consequence of the small number of optical components. The module can be flange-attached to an available microscope and in addition to the microscope has all the optical components necessary for fluorescence correlation spectroscopy in a compactly arrayed form. This eliminates the need for continuous readjustments of these components. The support body that holds the optical components can be produced economically using numerically controlled machine tools. The optical components are supported by receptacle holders that can be pre-mounted and then only need to be inserted in the support body. Because of the cantering shaped surfaces provided on the receptacle holders and on the support body, the need to readjust the optical components once oriented is eliminated. The entire confocal unit is built into the support body, which is designed as a block. The optical connection available on the microscope can be used for confocal imaging of the laser coupling and detection pinhole. The receptacle holders for the optical components are arrayed in conical receptacles in the support body, so that the filter can be changed without having to make any readjustments. The physically compact array of the optical components on the rigid support body ensures that it is insensitive to mechanical oscillations in the sample table.

The invention is described in greater detail with the aid of the illustrations. These show in:

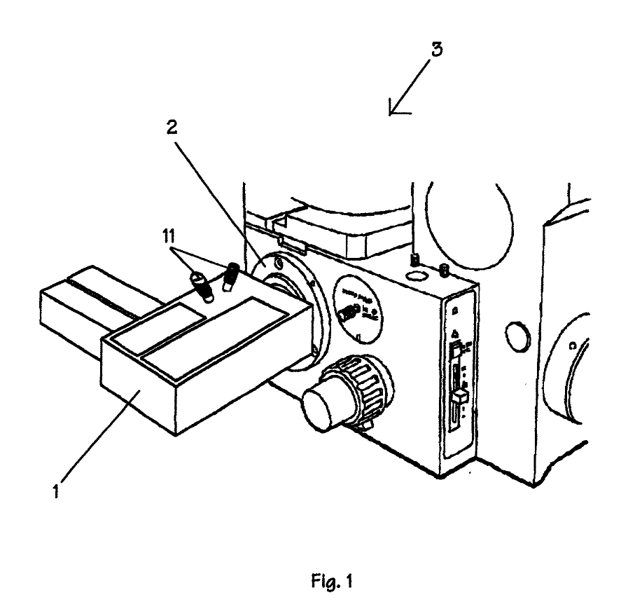

FIG. 1 a schematic perspective view of the fluorescence correlation spectroscopy module attached to a partially depicted microscope:

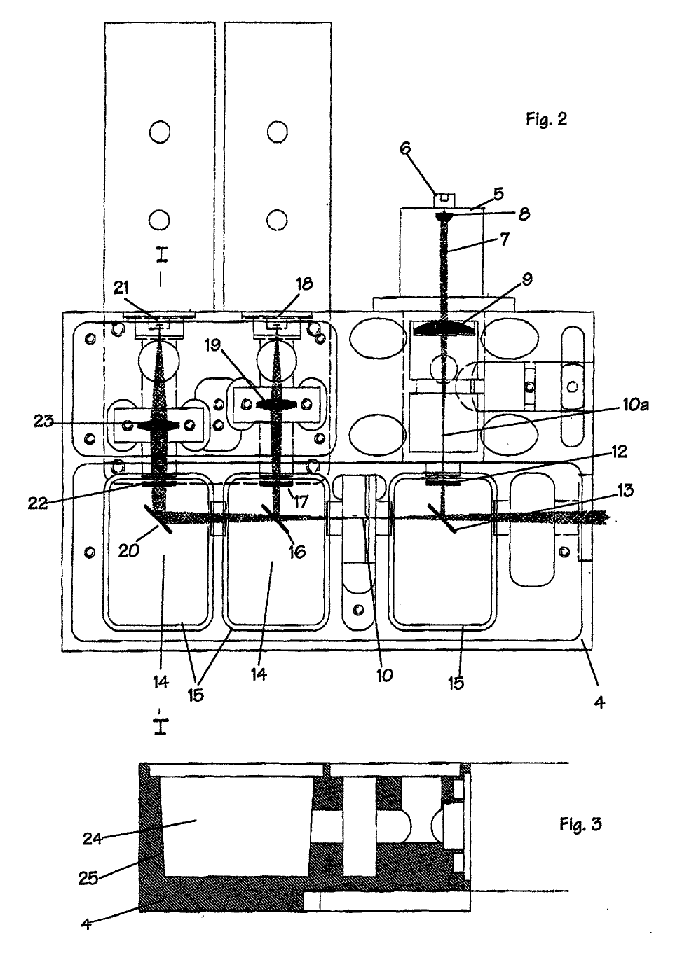

FIG. 2 a view from above of the module illustrated in FIG. 1;

FIG. 3 a cross-section I-I through FIG. 2;

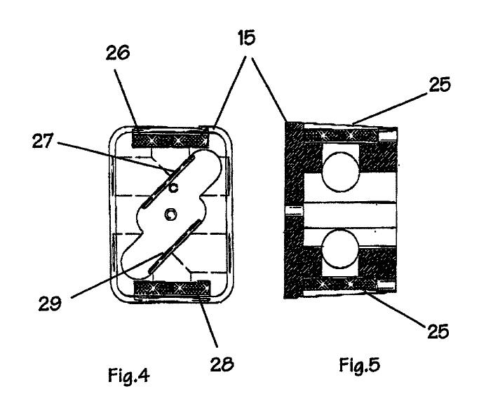

FIG. 4 a view from below of a receptacle holder with two sets of filter device and beam splitter; and

FIG. 5 a Cross-section through the receptacle support in FIG. 4.

As can easily be seen from FIG. 1, the fluorescence correlation spectroscopy module 1 in the embodiment illustrated is flange-attached to an optical outlet 2 of a partly illustrated microscope 3.

Such a microscope 3 usually has such an optical outlet, to which for example a CCD camera or a video camera can be flange-attached in order to record the sample volume set out on the microscope slide. This outlet is situated before the image plane of the microscope's intermediate image, in other words in the field of the microscope's projection lens, which can be observed through the eyepiece.

Through this outlet, light can be decoupled and subsequently also coupled into the microscope. The module 1 can be attached to the outlet 2 by a flange attachment shaped to match the outlet 2 of the microscope and arrayed on the module 1.

FIG. 2 of the illustration depicts the module 1 in a view from above, while the stimulating or emission beam path is also illustrated for the purpose of explanation.

The module 1 illustrated in FIG. 1 is attached to the optical outlet 2 of the microscope 3 by means of a flange connection not illustrated in detail provided in the area of the right lateral flange of the support body 4.

On a connection identified with the reference number 5, there is a flange connection 6 to which it is possible to attach an optical waveguide not illustrated in detail, by means of which a stimulating light generated by a laser can be coupled into the module 1. For this purpose, stimulating light of one or more wavelengths can be used, whereby the latter is advantageous, for example, if the sample volume contains molecules with fluorescence colorants.

Reference number 7 indicates the beam path of the coupled laser light. A collimator 8 is situated in the beam path 7, for the purpose of generating a beam path with a parallel orientation. The diameter of this beam determines the portion of aperture that is then used to illuminate the sample in the sample volume. The collimator 8 is therefore tuned to the numerical aperture of the fiber of the optical waveguide.

The collimator 8 follows a lens array 9 to the orientation of the beam path (focus 10a of the stimulating light) confocal with the pinhole 10. As can be seen from FIG. 1, the lens array 9 can be adjusted by means of schematically illustrated adjustment screws 11, for example micrometer screws, and can furthermore be regulated in the direction vertical to the beam path, so that adjustability in all three directions is guaranteed.

The beam path focused in this way subsequently comes up against a frequency-selective filter 12 whose purpose is to suppress unwanted wavelengths in the spectrum of the stimulating light. Reference number 13 identifies a dichroic beam splitter with which the stimulating light is deviated towards the optical outlet 2 of the microscope 3. In the microscope 3, the stimulating light is deviated through a projection lens onto the sample volume and stimulates the molecules endowed with fluorescent colorant to fluorescence.

The emission beam resulting from the fluorescence effect is decoupled through the optical outlet 2 of the microscope 3 through the projection lens of the microscope and coupled into the module 1, where it enters through the dichroic beam splitter 13 and the pinhole 10 into an optical unit 14 arrayed behind the pinhole 10 in the beam path.

The support body 4 then receives the receptacle holder 15 illustrated in FIGS. 4 and 5, on which the optical components of the module 1 are arrayed. As can easily be seen in FIG. 2 of the illustration, the module 1 has three receptacle holders 15 in the embodiment illustrated.

One of the three receptacle holders 15 holds the filter 12 already described and the beam splitter 13 and is thus situated in the beam path both of the stimulating light and of the emission beam, while the two further receptacle holders 15 are arrayed in the beam path of the emission beam behind the pinhole 10.

The optical unit 14 on the receptacle holder 15 consists of the embodiment illustrated, comprising a dichroic beam splitter 16 for decoupling a first trace wavelength of the emission beam and a filter 17 for the detection wavelength of the first channel. This is understood to be the first wavelength from the emission spectrum picked up by a detector 18. In the embodiment illustrated, a lens array 19 whose purpose is to concentrate the light of the first wavelength onto the sensitive part of the detector 18 is situated before the detector 18. A part of the emission beam passes the dichroic beam splitter 16 and subsequently strikes a mirror 20, which deviates the light towards a second detector 21, after it has passed through a filter 22 and a lens array 23.

As is clearly visible, there are two detectors 18, 21, together with two relative optical units 14, arrayed on the support body 4 in the embodiment illustrated. Nevertheless, it is possible to increase the number of optical units set in the beam path of the emission beam, for example to three or more optical units, in order to be able to evaluate several colors of the emission beam.

FIG. 1 of the drawing illustrates a cross-section I-I according to FIG. 2, whereby the optical components set in the plane of the cross-section have been left out of FIG. 3 for the sake of simplicity. As Is clearly evident from FIG. 3, however, for the purpose of receiving the receptacle holder 15, the support body has cavities 24 with sloping sides 25 whose form is complementary to the sides 26 (FIG. 5) of the receptacle holder 15, so that the receptacle holders 15 bearing the optical components can be inserted into the cavities 24 and thus adopt a defined centered position in the support body 4. This is a considerable advantage, as it is henceforth possible simply to exchange the receptacle holders 15 bearing the various different optical components, for example dichroic beam splitters and filters for different wavelengths of the stimulating and/or emission spectrum, as a receptacle holder 15 inserted into the support body 4 is oriented automatically to the beam path by virtue of the complementarily centering conical surfaces of the cavities 24 and of the receptacle holders 15.

FIGS. 4 and 5 illustrate optical units 14 and receptacle holders 15 with conical lateral surfaces 26 and optical components. In the embodiment illustrated, there are four optical components set on the receptacle holder 15.

Pairs of the optical components are arrayed reciprocally, i.e. the filter 26 and the beam splitter 27 or the filter 28 and the beam splitter 29. Instead of the beam splitters, however, it is also possible to provide for mirrors, so that for example a receptacle holder 15 can also hold a beam splitter and a mirror, each with a filter arrayed with it).

By simply removing a receptacle holder 15 from the cavity 24 in the support body 4, turning the extracted receptacle holder 15 through 180° and reinserting the turned receptacle holder 15 into the cavity 24, it is thus possible, for example to insert a filter-mirror combination or also a combination selecting another frequency range of the emission spectrum into the beam path of the emission beam in the place of the filter-beam splitter combination, without any readjustments being necessary. As a result of the centering surface shapes both on the receptacle holder and on the support body, the module is insensitive to oscillations occurring in the sample table, so that a high degree of reproducibility of the measurement results obtained with the module is guaranteed.

The module according to the invention can easily be flange attached to an inverse microscope. By virtue of the physically compact array of the light source, i.e. of the end of the fiber optical waveguide and of the pinhole, a thermal expansion and load of the Module resulting from oscillations does not affect the adjustment of the coupling and pinhole once it has been made, so that It is no longer necessary to keep on making readjustments.

The entire nodule contains only a very small number of components and the support body can be made cheaply. The module enables also such users who have a suitable microscope and a laser at their disposal to undertake fluorescence correlation spectroscopy. The lens arrays provided on the module can be adjusted by means of adjustment screws, for example micrometer screws. As this also applies to those lens arrays that concentrate the emission beam onto the detectors, it is no longer necessary to array the detectors on an x-y positioning table, whereby the aim is to achieve a compact, stable construction of the entire array. The filter and beam splitter both for the selection of the stimulating beam and for the emission beam are situated on the receptacle holder with conically centering lateral surfaces and can each house at least two combinations of optical components consisting of a filter and a beam splitter or a filter and a mirror, so that different spectrum ranges can be selected by simply removing and inserting the receptacle holder in the support body. The conical surfaces on the support body and on the receptacle holder provide for a very good degree of positioning precision of the optical components. A microscope equipped with the module according to the invention can be applied for the purposes of series measurements without any new adjustments being necessary for each measurement series. Several optical units can be arrayed one after the other in the beam path of the emission beam, so that several channels are available for evaluation at the Same time. Two channels can be used for high precision determination of diffusion coefficients, so that the sample and the standard can be measured simultaneously in one solution. In this case, errors do not influence the result, as such an error affects both channels. The use of two or more channels by means of two or more optical units enables information about the global movement of the fluorosphere to be gathered by means of a cross-correlation through the two or more color channels available with the said optical units. By splitting the emission light, for example to two detectors through two optical units, and by cross-correlating the measurement values, it is possible to overcome the influence of the dead times of detectors of this kind and also to measure extremely short diffusion times.

With regard to characteristics not explained individually in greater detail, express reference is made to the claims and to the drawing.

1. A fluorescence correlation spectroscopy module to be arrayed at an optical connection (2) of a microscope (3) with a connection (5) to the coupling of the stimulating light and of a pinhole array (10), wherein the coupling connection and the pinhole array are set on a common support body (4).

2. The module according to claim 11 characterized in that the optical connection (2) of the microscope is an optical inlet and/or outlet.

3. The module according to claim 1 or 2, characterized in that a collimator (8) for generating a parallel light beam is arrayed at the support body (4) in the bear path after the coupling connection (5).

4. The module according to claim 3, characterized in that an adjustable lens array (9) for focusing the beam path confocally with the pinhole is provided in the beam path after the collimator (8) at the support body (4).

5. The module according to one of the claims 1 to 4, characterized in that a filter array (12) and a dichroic beam splitter (13) are arrayed in the beam path before the stimulating light is coupled into the microscope (3).

6. The module according to claim 5, characterized in that the filter array (12) and the beam splitter (13) are set on a common receptacle holder (15) that can be inserted removably in the support body (4).

7. The module according to claims 1 through 6, characterized in that at least one optical unit (14) with one dichroic beam splitter (16) and/or one mirror (20) is provided in the emission beam path behind the pinhole (10).

8. The module according to claim 7, characterized in that the at least one optical unit (14) is arrayed on a receptacle holder (15) that can be inserted removably in the support body (4).

9. The module according to claim 7 or 8, characterized in that a filter (17, 22) for selecting the detection wavelengths is provided on the optical unit (14).

10. The module according to one of the claims 1 through 9, characterized in that a lens array (19, 23) for focusing the emission light on the detector (18, 21) is provided in the emission beam path before a detector (13, 21).

11. The module according to one of the claims 1 through 10, characterized in that the support body (4) for receiving the receptacle holder (15) is provided with shaped surfaces (25), to which the receptacle holder (15) provided with complementarily shaped surfaces arrayed on the support body in the beam path can be fixed.

12. The module according to one of the claims 1 through 11, characterized in that the support body (4) is made in one piece from a metallic material and has a connection flange for attaching the support body to the connection (2) of the microscope (3).

13. The module according to one of the claims 1 through 12, characterized in that the support body (4) is made with cavities (24) for receiving the receptacle holder (15), wherein the said cavities (24) have suitable lateral surfaces (25) designed to accomodate the oriented reception of the receptacle holder.

14. The module according to one of the claims 1 through 13, characterized in that the receptacle holders are provided with at least two frequency-selective filter devices (26, 28).

15. The module according to one of the claims 1 through 4, characterized in that the laser light used as stimulating light is coupled in through a single mode fiber optical waveguide.

16. The module according to one of the claims 3 through 15, characterized in that the collimator (8) is tuned to the numerical aperture of the fiber optical waveguide.

17. The module according to one of the claims 14 through 16, characterized in that it is possible to choose different spectrum ranges of the stimulating and/or emission wavelengths using the frequency-selective filter devices (26, 28).

18. A microscope with a fluorescence correlation spectroscopy module according to one of the above claims.

19. An application of the fluorescence correlation spectroscopy module according to one of the claims 1 through 17 or 18 for determining diffusion coefficients.

20. The application according to claim 19 for determining rotation diffusion coefficients.

21. An application of the fluorescence correlation spectroscopy module according to one of the claims 1 through 17 or 18 with at least two optical units for cross-correlating the signals of the different fluorescence emission spectra frequency selected by the at least two optical units.
